(19) United States
(12) Patent Application Publication
(10) Pub. No.: US 2008/0197590 A1
(43) Pub. Date: Aug. 21, 2008

(54) Handcart

(76) Inventor: Haiming Tsai, Ren-De Hsiang (TW)

Correspondence Address: Haiming TSAI, P.O. Box 6-9 (717), Tainan, omitted

(21) Appl. No.: 11/707,542

(22) Filed: Feb. 20, 2007

(51) Int. Cl. B62B 1/00

(52) U.S. Cl. 280/47.18

(57) ABSTRACT

The invention relates to a handcart composed of a main frame, a blocking board pivotally connected with the main frame, four wheel sets properly assembled under the main frame, and a foldable grip connected with the main frame. For operation, pull up the blocking board to stand vertically on the main frame to act as a deck and the grip to a proper position while using only two wheels to work. Also, four wheels can be used simultaneously to become a four-wheel handcart.

### BACKGROUND OF THE INVENTION

1. Field of the Invention

This invention relates to a handcart, particularly to one able to be alternatively used as a two-wheel or a four-wheel handcart.

2. Description of the Prior Art

Commonly, a conventional two-wheel handcart and four-wheel handcart are used as two different means, depending on practical need. In other words, each of the conventional handcarts can work only in a single way. With different shapes or packages of objects, some of them are suitable to be delivered by the two-wheel handcart and some are suitable to be delivered by the four-wheel handcart. Therefore, if both of the handcarts have to be used alternatively, they have to be of course prepared separately, not only increasing cost, but also occupying more space. Although the U.S. Pat. No. 6,938,905 patented by this inventor was provided to overcome the defects mentioned above, but it still has something to be improved, such as disassembly and collapse of its grip and wheels, etc.

### SUMMARY OF THE INVENTION

The objective of this invention is to offer a handcart.

The main characteristics of the invention are a main frame, a blocking board pivotally connected with the main frame, four-wheel sets properly assembled under the main frame, and a foldable grip connected with the main frame. For operation, pull up the blocking board to stand vertically on the main frame to act as a deck and the grip to a proper position while using only two wheels to work. Also, four wheels can be used simultaneously to become a four-wheel handcart.

### BRIEF DESCRIPTION OF DRAWINGS

This invention is better understood by referring to the accompanying drawings, wherein:

FIG. 1 is an exploded perspective view of a preferred embodiment of a hand c art in the present invention;

FIG. 2 is a perspective view of the preferred embodiment of a handcart in the present invention;

FIG. 3 is a side view of a wheel base of the preferred embodiment of a hand c art in the present invention, showing it being released from a pair of positioning holes;

FIG. 4 is a side view of the wheelbase of the preferred embodiment of a hand c art in the present invention, showing it being positioned in the other pair of positioning holes;

FIG. 5 is a perspective view of the preferred embodiment of a handcart in the present invention, showing it being used as a four-wheel handcart;

FIG. 6 is a perspective view of the preferred embodiment of a handcart in the present invention, showing it being used as a two-wheel handcart; and

FIG. 7 is a perspective view of the preferred embodiment of a handcart in the present invention, showing it being collapsed for storing.

### DETAILED DESCRIPTION OF THE PREFERRED EMBODIMENT

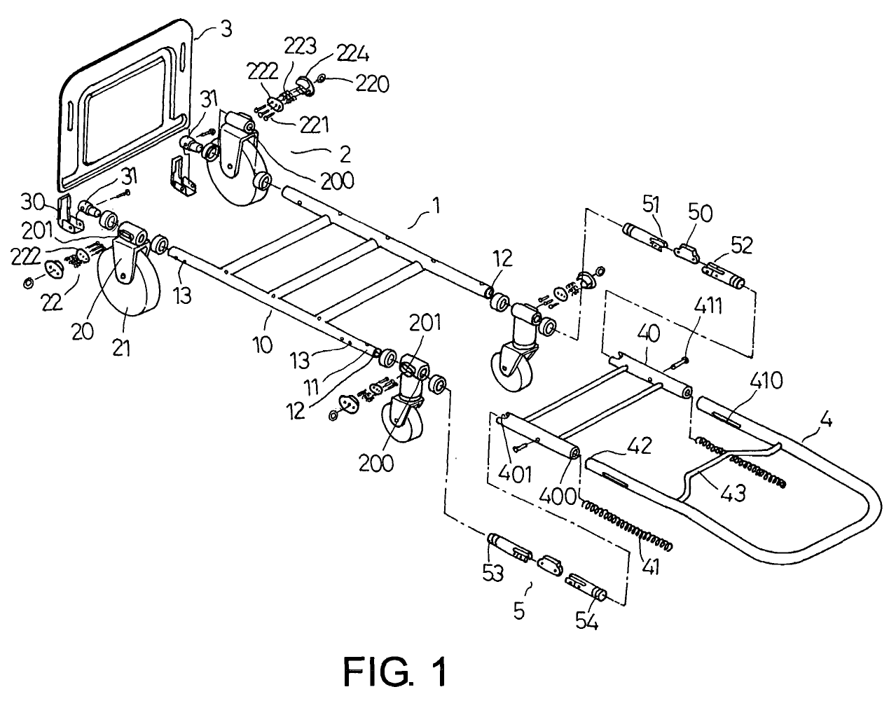

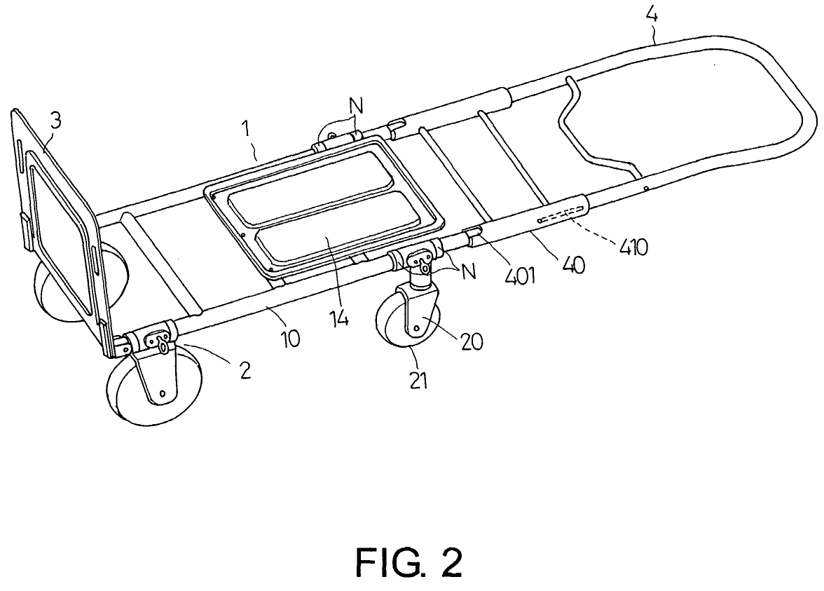

As shown in FIGS. 1˜7, a preferred embodiment of a handcart in the present invention is composed of a main frame 1, four wheel sets 2, a blocking board 3, a grip 4, a pair of joints 5 and plural positioning elements (N).

The main frame 1 is provided with a frame rod 10 that has each of its ends provided with a positioning portion 11 and an assembling portion 12, two pairs of positioning holes 13 bored on the positioning portion 11, and a deck 14 placed on the frame rod 10.

Each of the wheel sets 2 is assembled under the frame rod 10, provided with a wheelbase 20, a wheel 21, a positioning device 22 and a positioning hole 23. The wheel base 20 is provided with a through hole 200 for fitting with the frame rod 10, and a fitting hole 201. The positioning device 22 installed in the fitting hole 201 of the wheel base 20 is provided with a pulling member 220, two positioning bars 221, a positioning piece 222, three springs 223 and a cover 224. The positioning bars 221, the positioning piece 222 and the pulling member 220 are all compressed down by the springs 223 to enable the positioning bars 221 fitted in a pair of positioning holes 13 of the frame rod 10. On the contrary, the positioning bars 221 and the positioning piece 222 can be simultaneously pulled up via pulling the pulling member 220, keeping the positioning bars 221 coming off the positioning holes 13, so that the wheel base 20 is freed to become collapsible.

The blocking board 3 is pivotally connected with two assembling portion 12 of the main frame 1, provided with a pair of connecting angle bars 30 and a pair of pivotal connecting blocks 31.

The grip 4 is assembled on the frame rod 10 of the main frame 1, provided with a positioning sleeve 40, a pair of springs 41, an assembling portion 42 located at its two ends respectively, and a positioning bar 43 having its two ends inserted vertically in the tube of the grip 4. The springs 41 are to be inserted in the tube of the grip 4 to keep one of their ends extended against the ends of the positioning bar. Next, the assembling portions 42 of the grip 4 are inserted in two through holes 400 bored axially at two sides of the positioning sliding sleeve 40 so as to enable two positioning pins 411 inserted in two sliding slots 410 bored on the grip 4 to block the other ends of the springs 41, keeping the sliding sleeve 40 able to move along the grip 4. Also, the sliding sleeve 40 is provided with an U-shaped positioning groove 401 cut at its two bottom ends respectively.

Each of the joints 5 is assembled between the frame rod 10 of the main body 1 and the grip 4, provided with a pivotal connecting block 50, two pivotal connecting bases 51 and 52, and two engaging portions 53 and 54. The pivotal connecting bases 51 and 52 are respectively connected with two ends of the connecting block 50 pivotally, becoming foldable connections.

The positioning elements (N) are used to keep the wheel bases 20 restrictively positioned on the frame rod 10.

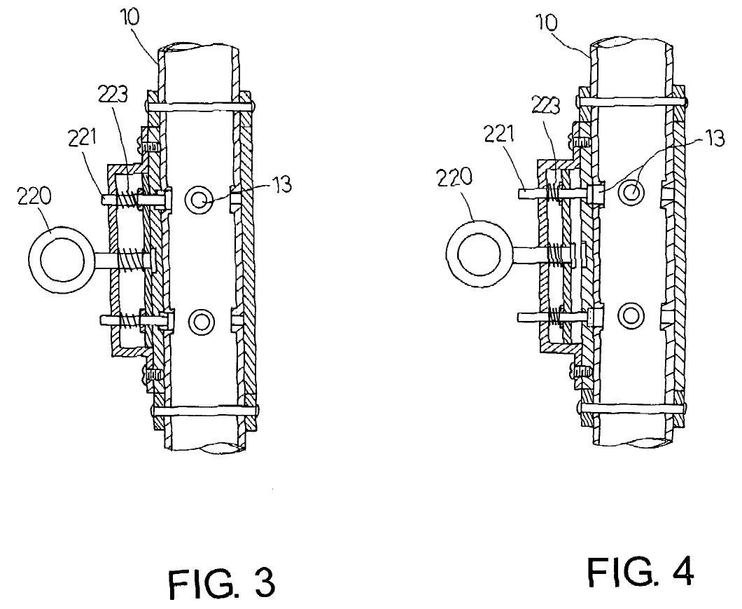

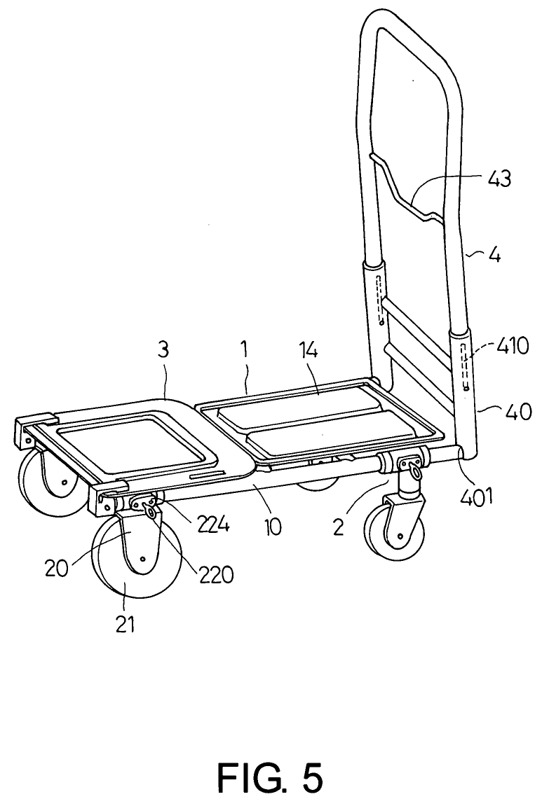

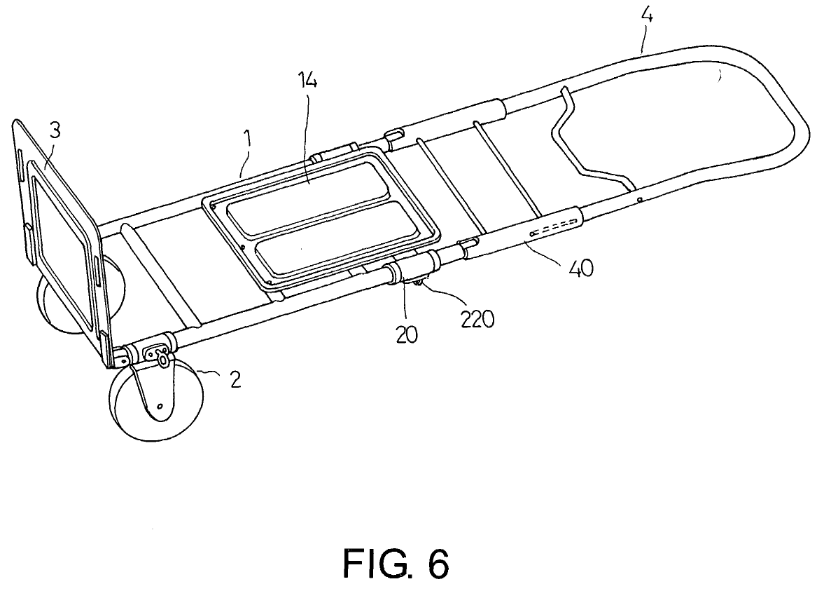

In using, when only two wheels of the invention are to be used, a user has first to pull up the blocking board 3 until it is vertical to the main frame 1, and next pull each of the pulling members 220 of the positioning devices 22 of the two wheel sets 2 close to the blocking board 3 to keep the positioning bars 221 coming off the positioning holes 13, as shown in FIG. 3, enabling the wheels 21 freed to rotate to a position ready for working. By the time, the pulling members 220 can be released so as to keep the positioning bars 221 compressed to plug into another pair of positioning holes 13 by the springs 223, as shown in FIG. 4. So, a two-wheel handcart of the invention shown in FIG. 6 is ready for work.

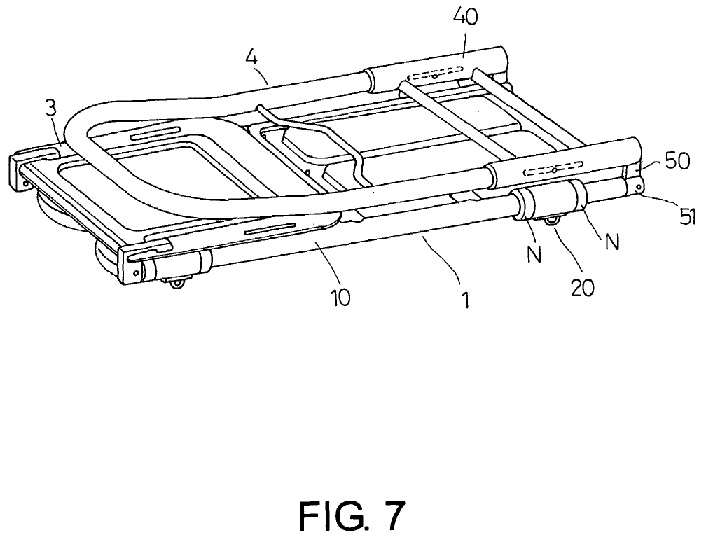

When all of the four wheels are needed to be available, each pulling member 220 of the positioning devices 22 of the four wheel sets 2 has to be pulled to keep the positioning bars 221 coming off the positioning holes 13, enabling the wheels 21 freed to rotate to a position ready for working. By the time, each pulling member 220 can be released so as to keep the positioning bars 221 compressed to plug into another pair of positioning holes 13 by the springs 223. Next, pull up the sliding sleeve 40 of the grip 4 to keep the grip 4 folded up to get vertical to the main frame 1, and then release the sliding sleeve 40 to enable it compressed by the springs 41 to move downward, keeping the U-shaped positioning grooves 401 of the sliding sleeve 40 mounted on the frame rod 10 of the main frame 1, as shown in FIG. 7.

The invention has the following advantages as can be seen from the foresaid description.

1. The blocking board 3 can be used as a bottom deck for loads and keep them from sliding off while using two wheels.

2. The blocking board 3 can be folded to flatly lie on the frame rod 10 while using four wheels, acting as a deck for reinforcing loading strength.

3. The invention can be alternatively used as a two-wheel and four-wheel handcart according to a user's need, achieving a convenient multi-function handcart.

4. The invention can be collapsed in a minimum bulk for economic delivery or saving space, because the wheels 21 and the grip 4 are foldable.

While the preferred embodiment of the invention has been described above, it will be recognized and understood that various modifications may be made therein and the appended claims are intended to cover all such modifications that may fall within the spirit and scope of the invention.

What is claimed is:

1. A handcart comprising:
a main frame provided with a frame rod that has each of its ends provided with a positioning portion and an assembling portion, two pairs of positioning holes bored on said positioning portion, and a deck placed on said frame rod; four wheel sets assembled under said frame rod and each of them provided with a wheel base, a wheel, a positioning device and a positioning hole, said wheel base provided with a through hole for fitting with said frame rod, and a fitting hole 201, said positioning device installed in said fitting hole of said wheel base and provided with a pulling member, two positioning bars, a positioning piece, three springs and a cover;
a blocking board pivotally fitted with two of said assembling portions of said frame rod and provided with a pair of connecting angle bars and a pair of pivotal connecting blocks;
a grip assembled on said frame rod of said main frame and provided with a positioning sleeve, a pair of springs, an assembling portion located at its two ends respectively, and a positioning bar, said springs inserted in the tube of said grip to keep one of their ends extended against the ends of the positioning bar, said assembling portions of said grip inserted in two through holes of said positioning sleeve to enable two positioning bolts inserted in two sliding slots bored on said grip to block the other ends of said springs;
a pair of joints assembled between said frame rod of said main body and said grip and each of them provided with a pivotal connecting block, two pivotal connecting bases and two engaging portions, said pivotal connecting bases and said pivotal connecting block connected together to become foldable, said engaging portions fitted with said assembling portions of said frame rod and said grip respectively; and plural positioning elements used to keep said wheel bases restrictively positioned on said frame rod so as to enable said grip to be foldable;

2. A handcart comprising:
a main frame having a frame rod that is connected with two joints at its two upper ends, each of said joints composed of a pivotal connecting block and two pivotal connecting bases;
a grip pivotally connected with said joints of said frame rod of said main frame; and
four wheel sets fixed on said frame rod of said main frame and each of them provided with a positioning device, plural positioning bars and a pulling member to keep a wheel freed or positioned to be folded or to work.

3. A handcart comprising:
a main frame composed of plural wheel sets and a frame rod, said frame rod connected with two joints at its two upper ends, each of said joints composed of a pivotal connecting block and two pivotal connecting bases;
a blocking board pivotally connected on said frame rod of said main frame; and
a grip pivotally connected with said joints of said frame rod of said main frame and provided with a positioning sliding sleeve that has an U-shaped positioning groove cut at its two bottom ends respectively for fitting with said main frame to get freed or positioned.
